(19) United States
(12) Patent Application Publication
(10) Pub. No.: US 2026/0135683 A1
(43) Pub. Date: May 14, 2026

(54) METHOD AND APPARATUS FOR MULTIMODAL LEARNING-BASED FREQUENCY DIVISION DUPLEXING (FDD) MASSIVE MULTIPLE-INPUT MULTIPLE-OUTPUT (mMIMO) DOWNLINK CHANNEL ESTIMATION

(71) Applicant: Korea Advanced Institute of Science and Technology, Daejeon (KR)

(72) Inventors: Hyuncheol Park, Daejeon (KR); Jinman Kwon, Daejeon (KR)

(73) Assignee: Korea Advanced Institute of Science and Technology, Daejeon (KR)

(21) Appl. No.: 19/372,080

(22) Filed: Oct. 28, 2025

(30) Foreign Application Priority Data
Nov. 13, 2024 (KR) 10-2024-0160626
Nov. 18, 2024 (KR) 10-2024-0163869

(51) Int. Cl. H04L 5/14; H04B 7/0413; H04B 17/391; H04L 25/02

(52) U.S. Cl. CPC H04L 5/14; H04B 7/0413; H04B 17/391; H04L 25/0202

(57) ABSTRACT

Provided is a method and system for multimodal learning-based frequency division duplexing (FDD) massive multiple-input multiple-output (MIMO) downlink channel estimation. The multimodal learning-based FDD mMIMO downlink channel estimation system includes a multi-modality selector configured to select multi-modal data for deep learning based on a partial channel reciprocity to estimate a channel of an FDD mMIMO system; a preprocessing unit configured to preprocess the selected multi-modal data to training data for channel estimation; a multimodal deep neural network (DNN) modeling unit configured to perform multimodal DNN modeling based on a multimodal knowledge distillation technique for solving a modality laziness problem using the preprocessed multi-modal data; and a multimodal DNN training unit configured to estimate a downlink channel of the FDD mMIMO system by training a multimodal DNN model.

### CROSS-REFERENCE TO RELATED APPLICATIONS

This application claims the priority benefit of Korean Patent Application No. 10-2024-0160626, filed on Nov. 13, 2024, and Korean Patent Application No. 10-2024-0163869, filed on Nov. 18, 2024, in the Korean Intellectual Property Office, the disclosures of which are incorporated herein by reference.

### BACKGROUND

### 1. Field of the Invention

Example embodiments relate to a method and system for multimodal learning-based frequency division duplexing (FDD) massive multiple-input multiple-output (mMIMO) downlink channel estimation.

### 2. Description of the Related Art

A massive multiple-input multiple-output (mMIMO) system is one of core technologies of future wireless communication networks that may significantly increase the capacity and the spectral efficiency (SE) by allowing a base station equipped with large-scale massive array antennas to serve a plurality of users.

To fully realize the advantages of the mMIMO system, the availability of accurate downlink (DL) channel state information (CSI) is an essential element. However, the computational complexity of DL channel estimation and the number of pilot signals required for accurate channel estimation are proportional to the number of antennas. Therefore, in the case of the mMIMO system that deploys a large array of antennas, the computational complexity of DL channel estimation to directly acquire DL CSI is very high, and a large number of pilot signals are required.

A method of distinguishing uplink (UL) and DL between a base station and a user may be broadly divided into time division duplexing (TDD) and frequency division duplexing (FDD).

TDD refers to a duplexing method that allocates different time slots to UL and DL in the same frequency band and uses the same frequency band for signal transmission. FDD refers to a duplexing method that allocates different frequency bands to UL and DL and uses the frequency bands for signal transmission.

Compared to FDD, TDD uses the same frequency band, so channel reciprocity between UL and DL is present. Therefore, DL CSI may be easily acquired through UL CSI which is relatively easy to acquire compared to DL. However, TDD has the disadvantage that a high-speed transmission is disadvantageous, and a long transmission delay is required. From the practical standpoint, since FDD is used in most cellular networks, the infrastructure for this is already built, which may be easily used by a network operator. Due to such an advantage, it is still important to consider FDD. Unlike TDD, FDD lacks the channel reciprocity between UL and DL, making it difficult to acquire accurate DL CSI by utilizing UL CSI acquired using a UL pilot signal as in TDD.

Due to the insufficient channel reciprocity, DL CSI is not the same as UL CSI, so a DL channel may not be estimated from a UL channel, which causes the additional DL training overhead to acquire DL CSI. Since DL CSI needs to be estimated for each UE, a sufficient number of pilot signals are required, which causes the signaling overhead. Since DL CSI estimated by each UE needs to be fed back to a base station (BS), the design of an additional feedback loop is required, which causes the CSI feedback overhead. Due to these problems, a channel estimation technique is required that may acquire an accurate DL channel while reducing the overhead required by the existing method of estimating a channel of an FDD mMIMO system.

Non-patent documents are as follows:
[1] Y. Yang, F. Gao, G. Y. Li, and M. Jian, “Deep learning based downlink channel prediction for FDD mMIMO system,” IEEE Commun. Lett., vol. 23, no. 11, pp. 1994-1998
[2] Y., Yang, F., Gao, C., Xing, J., An, and A, Alkhateeb, “Deep multimodal learning: Merging sensory data for mMIMO channel prediction,” IEEE J. Sel. Areas Commun, vol. 39, no. 7, pp. 1885-1898
[3] D Han, J Park, N Lee, “FDD MMIMO Without CSI Feedback,” IEEE Trans. on Wireless Commun., early access

### SUMMARY

A technical subject to be achieved by the present invention is to provide a method and system for multimodal learning-based downlink (DL) channel estimation for a frequency division duplexing (FDD) massive multiple-input multiple-output (mMIMO) system. According to an example embodiment, a reasonable strategy for selecting a modality based on a partial channel reciprocity is proposed, and the selected modalities may provide complementary information for DL channel estimation. To learn complementary information from the selected modality and to solve a modality laziness problem inherent in an existing multimodal learning-based method, a multimodal deep neural network (DNN) modeling method is proposed based on a multimodal knowledge distillation method. Also, an effective loss function that integrates the effect of joint learning and distilled knowledge into the overall learning process is proposed.

According to an aspect, a multimodal learning-based FDD mMIMO downlink channel estimation system proposed herein includes a multi-modality selector configured to select multi-modal data for deep learning based on a partial channel reciprocity to estimate a channel of an FDD mMIMO system; a preprocessing unit configured to preprocess the selected multi-modal data to training data for channel estimation; a multimodal DNN modeling unit configured to perform multimodal DNN modeling based on a multimodal knowledge distillation technique for solving a modality laziness problem using the preprocessed multi-modal data; and a multimodal DNN training unit configured to estimate a downlink channel of the FDD mMIMO system by training a multimodal DNN model.

The multi-modality selector is configured to select out-of-band information based on model information of the system and a geometric channel reciprocity as training modality data for multimodal deep learning, to estimate the downlink channel of the FDD mMIMO system.

The multi-modality selector is configured to select uplink out-of-band information and uplink channel information for estimating the downlink channel from among uplink-related parameters as the training modality data for multimodal deep learning, and the out-of-band information is a frequency-independent parameter.

The preprocessing unit is configured to perform data preprocessing including data scaling, aggregation, normalization, outlier removal, and handling missing data to consistently match the quality of different modality data for the selected multi-modality for multimodal deep learning.

The multimodal DNN training unit is configured to compress the multi-modal data to features through a subnetwork (SubNetwork) for each of the multi-modal data using the preprocessed multi-modal data as input, to fuse the compressed features through a fusion network (FusionNetwork), and to reconstruct the fused features to the downlink channel through a post-fusion network (PostFusionNetwork).

The multimodal DNN training unit is configured to select a distillation loss function as the mean squared error (MSE), such that the subnetwork performs deep learning using information of a teacher network distilled with the multimodal knowledge distillation technique.

The multimodal DNN training unit is configured to compute a multimodal loss function, such that the subnetwork performs deep learning on information of all modalities, and to compute a final loss function in such a manner that a student network of the subnetwork learns information of all modalities and information distilled from a teacher network.

According to another aspect, a multimodal learning-based FDD mMIMO downlink channel estimation method proposed herein includes selecting, through a multi-modality selector, multi-modal data for deep learning based on a partial channel reciprocity to estimate a channel of an FDD mMIMO system; preprocessing, through a preprocessing unit, the selected multi-modal data to training data for channel estimation; performing, through a multimodal DNN modeling unit, multimodal DNN modeling based on a multimodal knowledge distillation technique for solving a modality laziness problem using the preprocessed multi-modal data; and estimating, through a multimodal DNN training unit, a downlink channel of the FDD mMIMO system by training a multimodal DNN model.

According to some example embodiments, by utilizing, as modality data, frequency-independent parameters that are model information of a UL channel, which is relatively easy to acquire compared to DL, and out-of-band information, it is possible to reduce the overhead required in the existing DL channel estimation technology of an FDD mMIMO system. Also, by reflecting complementary information of frequency-independent various modality data of a channel in a DNN training process, it is possible to improve estimation accuracy compared to the existing channel estimation technology. A channel estimation method proposed herein is data-driven, so may be applied to ultra-high frequency communication, such as terahertz and millimeter waves. It is possible to solve the difficulty in DL channel estimation due to the insufficient reciprocity between UL and DL of FDD, and to improve the performance of the existing communication technology based on channel estimation using a channel estimated with high accuracy. Also, the proposed technique refers to a technology for an FDD mode that is an infrastructure of the existing cellular network, and thus may be immediately applied without significantly changing the existing infrastructure.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 illustrates a system model according to an example embodiment;

FIG. 2 is a diagram illustrating a multimodal learning-based frequency division duplexing (FDD) massive multiple-input multiple-output (MIMO) downlink channel estimation system according to an example embodiment;

FIG. 3 illustrates the overall structure and a conceptual learning diagram of a deep neural network (DNN) utilized in a channel estimation technique according to an example embodiment;

FIG. 4 illustrates a structure and a conceptual learning diagram of a multimodal knowledge distillation-based Teacher-Student SubNetwork that is an example of a SubNetwork utilized in a channel estimation technique according to an example embodiment;

FIG. 5 illustrates a structure and a conceptual learning diagram of a FusionNetwork that is utilized in a channel estimation technique according to an example embodiment;

FIG. 6 illustrates a structure and a conceptual learning diagram of a PostFusionNetwork that is utilized in a channel estimation technique according to an example embodiment;

FIG. 7 is a flowchart illustrating a multimodal learning-based FDD mMIMO downlink channel estimation method according to an example embodiment; and

FIG. 8 is a graph comparing the normalized mean squared error (NMSE) performance between a channel estimation technique according to an example embodiment and the existing channel estimation technique.

### DETAILED DESCRIPTION

Hereinafter, example embodiments will be described with reference to the accompanying drawings.

Deep learning refers to one field of machine learning and is also a method that attempts to achieve a high level of abstraction by learning a large amount of data using a deep neural network (DNN) in which layers of an artificial neural network (ANN) are successively and deeply stacked. Supervised learning, which is one of various deep learning methods, is a method of acquiring an estimate or prediction value for new data through a trained DNN by training the DNN to learn complex nonlinear relationships between training data. Since a channel is estimated through a relationship between input data and output data of the DNN, the deep learning-based channel estimation method may effectively reduce the overhead caused by estimating a DL channel of the existing FDD mMIMO system. However, in the existing deep learning-based channel estimation method, since the DNN is trained through training data that includes a single pair of input data and output data, the accuracy of an estimate or prediction value of the DNN is limited due to the limited amount of information in input data.

In a communication system, there is out-of-band side information that may be utilized to improve the system performance, including a sub-6G channel, a user equipment (UE) location, and a path loss. In particular, it has been regarded that the channel reciprocity between UL and DL was absent in FDD, but there are frequency-independent channel parameters that constitute a channel model, so the reciprocity is partially present. These parameters may be regarded as the out-of-band side information. The existing communication technology including channel estimation have been barely able to take advantage of this out-of-band side information due to the absence of a mathematical model that may easily handle this information. However, the development in the deep learning technology makes it possible to utilize previously unavailable out-of-band side information, and this enables the communication system to achieve better performance.

Model information refers to information that may be acquired through existing technologies. For example, in a channel estimation problem, a DL channel estimated through a least square (LS) channel estimation method or a linear mean squared error (LMMSE) channel estimation method utilizing an UL pilot signal may be regarded as the model information. Rather than relying solely on data, advantages may be acquired through the guidance of model information, which enables the communication system to achieve better performance.

Multimodal deep learning refers to a kind of the deep learning technology inspired by a recognition method through the five senses from the human brain, and is a method of training a DNN by utilizing heterogeneous and various modality data as input data for output data of the same DNN. Also, multimodal deep learning is a method that enables more accurate estimation or prediction of the DNN than the existing deep learning-based method by reflecting complementary information that may be present in different modality data during training of the DNN. Also, in the case of training the DNN using previously unavailable out-of-band side information as modality data, the channel estimation performance may be improved through complementary information that is contained in the out-of-band side information. However, since heterogeneous and various modality data are used to train the DNN, dominant data in the modality data may have a dominant influence on the training result of the DNN. Therefore, there is a need for a training strategy that allows the DNN to effectively learn various modality data.

Similar to the existing deep learning method, since a channel is estimated using the relationship between a variety of input modality data and output data, it is possible to reduce the overhead caused by estimating a DL channel of the existing FDD mMIMO system. However, since various modality data with different statistical characteristics and forms are used for learning, there is a need for a DNN training strategy that may effectively combine the modality data and reflect complementary information of modalities during DNN training, and a DNN modeling strategy.

A DNN trained using multimodal data based on naive multimodal joint training has worse performance than that of a DNN trained using unimodal data. A DNN tends to preferentially learn easy patterns and to exclude difficult patterns from training data due to memorization effects, which is called simplicity bias. In multimodal deep learning that utilizes various modality data for DNN training, due to a modality laziness problem that, if the DNN preferentially learns modality data that is easy to learn first due to the simplicity bias, a training error of the modality data becomes 0 and the joint training no longer proceeds and learning ends although a training error of other modality data does not become 0, the performance of the existing naive multimodal joint training method may not be better than that of a unimodal training method. There is a need for a DNN design method and a DNN training method that may mitigate the modality laziness problem, and may improve the performance of the multimodal learning-based multimodal joint training method by sufficiently training a subnetwork (SubNetwork) of each unimodal data.

Naive multimodal joint training has the modality laziness problem that DNN training terminates early, although the DNN has not sufficiently learned information on each modality data. In existing deep learning, a knowledge distillation technique has been utilized to make an output distribution value of a teacher network, which is a pretrained large DNN, and distribution or values of features similar to those of a student network, which is a DNN equal to or smaller than the teacher network, during a DNN training process. Inspired by this technique, the modality laziness problem may be solved through a multimodal knowledge distillation technique that pretrains multi-modal data with each TeacherSubNetwork and makes an output distribution value of the trained TeacherSubNetwork and distribution or values of features similar to those of StudentSubNetwork.

The present invention proposes a multimodal learning-based DL channel estimation technology for an FDD mMIMO system. The proposed technology proposes a reasonable strategy that selects a modality based on a partial channel reciprocity, enabling the selected modalities to provide complementary information for DL channel estimation. To learn complementary information from the selected modality and to solve the modality laziness problem inherent in the existing multimodal learning-based method, a multimodal DNN modeling method is proposed based on a multimodal knowledge distillation method. Also, an effective loss function that integrates the effect of joint learning and distilled knowledge into the overall learning process is proposed.

To estimate a DL channel in the existing FDD mMIMO system, a pilot signal with a certain length known to both a transmitter and a receiver is transmitted from a base station (BS) to a UE, and DL CSI is estimated from the received pilot signal and fed back from the UE to the BS to estimate the channel.

However, in the existing method, as additional DL training is needed to estimate the DL channel, unlike time division duplexing (TDD), due to the insufficient channel reciprocity and large-scale antennas mounted to the BS, the additional DL training overhead is required due to this process, as a sufficiently long pilot signal for accurate channel estimation is needed, the signaling overhead is required, and as a feedback loop is needed to feed back DL CSI estimated by the UE to the BS, the feedback overhead is required.

Therefore, using a sufficiently long pilot signal for accurate channel estimation may reduce the number of data that may be transmitted within a correlation time, and may degrade the transmission efficiency. Using an insufficient pilot signal to increase the transmission efficiency may reduce the accuracy of channel estimation, which leads to lowering a transmission rate. Therefore, there is a need for a channel estimation technique that may secure channel estimation accuracy while reducing the overhead required for DL channel estimation in the existing FDD mMIMO system.

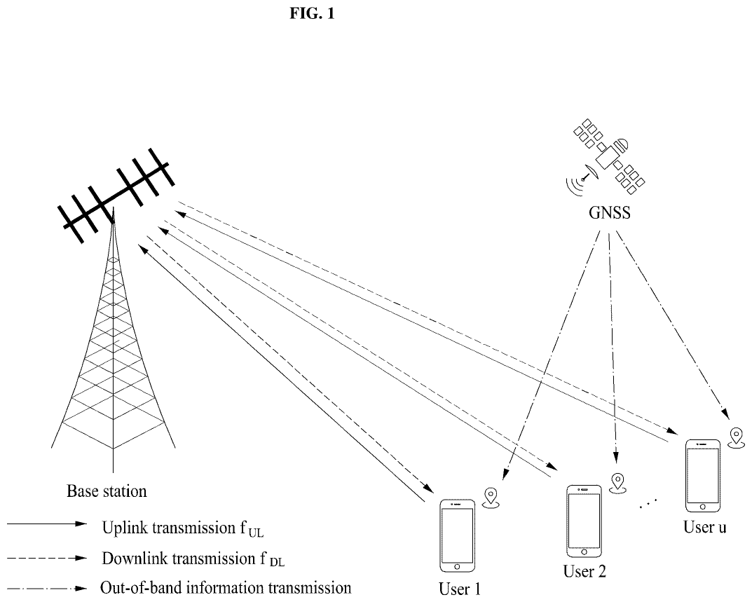

FIG. 1 illustrates a system model according to an example embodiment.

The present invention proposes a multi-modality selection process, a multi-modality training data preprocessing process, a DNN modeling strategy, and a DNN training strategy, to estimate a DL channel of the FDD mMIMO system using multimodal deep learning.

The system model according to an example embodiment considers an mMIMO system as shown in FIG. 1 in which a base station equipped with N_{BS}>>1 receiving antennas is communicating with u user equipments (UEs), each having a single antenna (N_{UE}=1), sensor devices, and a location service. It is assumed that both UL and DL of a system according to an example embodiment operate in an FDD mode. It is assumed that both UL and DL of the system according to an example embodiment operate in an orthogonal frequency division multiplexing (OFDM) mode having k subcarriers. Channel models of UL and DL and an array response vector of the system according to an example embodiment are as follows:

$${H}_{u} ( {f}_{k}^{UL} ) = {\sum }_{l = 1}^{{L}_{u}^{UL}} {α}_{l , u}^{UL} {e}^{- j 2 π {f}_{k}^{UL} {γ}_{k , l} + {ϕ}_{u , l}^{UL}} a ( {θ}_{u , l}^{UL} , {f}_{k}^{UL} )$$

$$a ( {θ}_{u , l}^{UL} , {f}_{k}^{UL} ) = {[ 1 , {e}^{- j 2 π {f}_{k}^{UL} dsin ( {θ}_{u , l}^{UL} )} , … , {e}^{- j 2 π {f}_{k}^{UL} ( N - 1 ) dsin ( {θ}_{u , l}^{UL} )} ]}^{T}$$

$${H}_{u} ( {f}_{k}^{DL} ) = {\sum }_{l = 1}^{{L}_{u}^{DL}} {α}_{l , u}^{DL} {e}^{- j 2 π {f}_{k}^{DL} {γ}_{k , l} + {ϕ}_{u , l}^{DL}} a ( {θ}_{u , l}^{DL} , {f}_{k}^{DL} )$$

$$a ( {θ}_{u , l}^{DL} , {f}_{k}^{DL} ) = {[ 1 , {e}^{- j 2 π {f}_{k}^{DL} dsin ( {θ}_{u , l}^{DL} )} , … , {e}^{- j 2 π {f}_{k}^{DL} ( N - 1 ) dsin ( {θ}_{u , l}^{DL} )} ]}^{T}$$

Here,

$${H}_{u} ( {f}_{k}^{UL} ) and {H}_{u} ( {f}_{k}^{DL} )$$

represent a UL channel matrix from a UE u to a base station (BS) and a DL channel matrix from the BS to the UE u, respectively.

$${θ}_{u , l}^{UL}$$

denote angles of arrivals (AoAs) of UL, and

$${θ}_{u , l}^{DL}$$

denote angles of departures (AoDs) of DL.

$${f}_{k}^{UL} and {f}_{k}^{DL}$$

denote the carrier frequency of UL and the carrier frequency of DL, respectively.

$${L}_{u}^{UL} and {L}_{u}^{DL}$$

denote the number of multipaths of UL and the number of multipaths of DL, respectively.

$${α}_{l , u}^{UL} and {α}_{l , u}^{DL}$$

denote an l-th path attenuation term from the UE u to the BS in the UL channel and an l-th attenuation term from the BS to the UE u in the DL channel, respectively.

γ_{k,l} denotes a path distance.

$${ϕ}_{u , l}^{UL} and {ϕ}_{u , l}^{DL}$$

denote wavelength-independent phase shifts of UL and DL, respectively, and are uniformly distributed over [0,2π) to capture the small-scale fading effect due to a path reflection.

d denotes an interval between antennas.

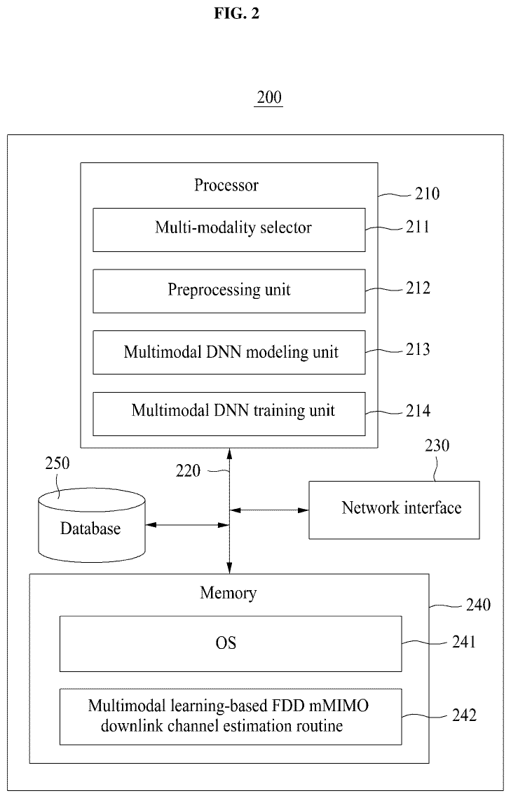

FIG. 2 is a diagram illustrating a multimodal learning-based FDD mMIMO downlink channel estimation system according to an example embodiment.

A MIMO downlink channel estimation system 200 according to the example embodiment may include a processor 210, a bus 220, a network interface 230, a memory 240, and a database 250. The memory 240 may include an operating system (OS) 241 and a multimodal learning-based FDD mMIMO downlink channel estimation routine 242. The processor 210 may include a multi-modality selector 211, a preprocessing unit 212, a multimodal DNN modeling unit 213, and a multimodal DNN training unit 214. In another example embodiment, the MIMO downlink channel estimation system 200 may include more components than the components shown in FIG. 2. However, there is no need to clearly illustrate most conventional components. For example, the MIMO downlink channel estimation system 200 may include other components, such as a display or a transceiver.

The memory 240 may include a permanent mass storage device, such as a random access memory (RAM), a read only memory (ROM), and a disk drive, as computer-readable recording media. Also, the memory 240 may include a program code for the OS 241 and the multimodal learning-based FDD mMIMO downlink channel estimation routine 242. These software components may be loaded from computer-readable recording media separate from the memory 240 using a drive mechanism (not shown). Examples of the separate computer-readable recording media may include a floppy drive, a disc, a tape, a DVD/CD-ROM drive, and a memory card. In another example embodiment, the software components may be loaded to the memory 240 through the network interface 230 rather than the computer-readable recording media.

The bus 220 may enable communication and data transmission between the components of the MIMO downlink channel estimation system 200. The bus 220 may be configured using a high-speed serial bus, a parallel bus, a storage area network (SAN), and/or other appropriate communication technology.

The network interface 230 may be a computer hardware component to connect the MIMO downlink channel estimation system 200 to a computer network. The network interface 230 may connect the MIMO downlink channel estimation system 200 to the computer network through a wireless or wired connection.

The database 250 may serve to store and maintain all information necessary for multimodal learning-based FDD mMIMO downlink channel estimation. FIG. 2 illustrates that the database 250 is built and included in the MIMO downlink channel estimation system 200, but without being limited thereto, it may be omitted depending on a system implementation method or environment or may be present as an external database in which the entire database or a portion of the database is constructed on another separate system.

The processor 210 may be configured to process instructions of the computer program by performing basic arithmetic operations, logic operations, and I/O operations of the MIMO downlink channel estimation system 200. The instructions may be provided from the memory 240 or the network interface 230 to the processor 210 through the bus 220. The processor 210 may be configured to execute a program code for the multi-modality selector 211, the preprocessing unit 212, the multimodal DNN modeling unit 213, and the multimodal DNN training unit 214. The program code may be stored in a storage device, such as the memory 240.

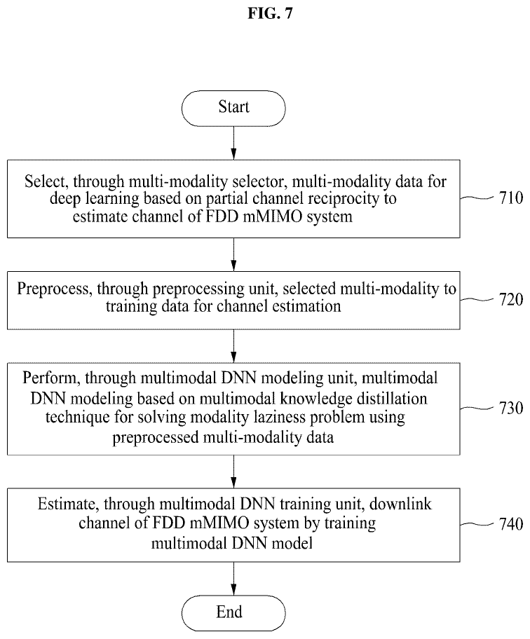

The multi-modality selector 211, the preprocessing unit 212, the multimodal DNN modeling unit 213, and the multimodal DNN training unit 214 may be configured to perform operations 710 to 740 of FIG. 7.

The MIMO downlink channel estimation system 200 may include the multi-modality selector 211, the preprocessing unit 212, the multimodal DNN modeling unit 213, and the multimodal DNN training unit 214.

The multi-modality selector 211 according to an example embodiment selects multi-modal data for deep learning based on partial channel reciprocity to estimate a channel of an FDD mMIMO system.

The multi-modality selector 211 according to an example embodiment selects out-of-band information based on model information of the system and geometric channel reciprocity as training modality data for multimodal deep learning, to estimate the downlink channel of the FDD mMIMO system.

The multi-modality selector 211 according to an example embodiment selects uplink out-of-band information and uplink channel information for estimating the downlink channel from among uplink-related parameters as training modality data for multimodal deep learning, and the out-of-band information is a frequency-independent parameter.

The preprocessing unit 212 according to an example embodiment preprocesses the selected multimodality to training data for channel estimation.

The preprocessing unit 212 according to an example embodiment performs data preprocessing including data scaling, aggregation, normalization, outlier removal, and handling missing data to consistently match the quality of different modality data with respect to the selected multimodality for multimodal deep learning.

The multimodal DNN modeling unit 213 according to an example embodiment performs multimodal DNN modeling based on a multimodal knowledge distillation technique for solving a modality laziness problem using the preprocessed multimodal data.

The multimodal DNN training unit 214 according to an example embodiment estimates a downlink channel of the FDD mMIMO system by training a multimodal DNN model.

The multimodal DNN training unit 214 according to an example embodiment compresses the multi-modal data to features through a subnetwork (SubNetwork) for each of the multi-modal data uses the preprocessed multi-modal data as input, fuses the compressed features through a fusion network (FusionNetwork), and reconstructs the fused features the downlink channel through a post-fusion network (PostFusionNetwork).

The multimodal DNN training unit 214 according to an example embodiment selects a distillation loss function as mean squared error (MSE), such that the subnetwork performs deep learning using information of a teacher network distilled using the multimodal knowledge distillation technique.

The multimodal DNN training unit 214 according to an example embodiment computes a multimodal loss function, such that the subnetwork performs deep learning on information of all modalities, and computes a final loss function in such a manner that a student network of the subnetwork learns information of all modalities and information distilled from a teacher network.

A multi-modality selection process using out-of-band side information according to an example embodiment is described. Initially, in a system according to an example embodiment, a location of a UE is the same in both UL and DL due to the geographical symmetry of an mMIMO system.

$${D}_{( x , y , z )} = {D}_{( x , y , z )}^{UL} = {D}_{( x , y , z )}^{DL}$$

Location information of the UE may be acquired through a variety of technologies, particularly, a positioning function of a global navigation satellite system (GNSS).

Since the existing FDD mMIMO system allocates different frequencies to UL and DL and accordingly, lacks a channel reciprocity, it is known to be unable to estimate a DL channel from a UL channel estimated from a UL pilot signal, which differs from TDD. However, if analyzing channel models of UL and DL, some important geometric parameters of UL and DL channels are generally frequency-independent and are the same regardless of the frequencies of UL and DL. Frequency-dependent and frequency-independent parameters in UL and DL channel models are as follows:

$$\begin{matrix}{H}_{u} ( {f}_{k}^{UL} ) = {\sum }_{l = 1}^{{L}_{u}^{UL}} {α}_{u , l}^{UL} {e}^{- j 2 π {f}_{k}^{UL} {γ}_{u , l} + {ϕ}_{u , l}^{UL}} a ( {θ}_{u , l}^{UL} , {f}_{k}^{UL} ) \\ {H}_{u} ( {f}_{k}^{DL} ) = {\sum }_{l = 1}^{{L}_{u}^{DL}} {α}_{u , l}^{DL} {e}^{- j 2 π {f}_{k}^{DL} {γ}_{u , l} + {ϕ}_{u , l}^{DL}} a ( {θ}_{u , l}^{DL} , {f}_{k}^{DL} )\end{matrix}$$

$${f}_{k}^{UL} and {f}_{k}^{DL}$$

parameters are frequency-dependent parameters, and

$${L}_{u}^{UL} , {L}_{u}^{DL} , {α}_{u , l}^{UL} , {α}_{u , l}^{DL} , {γ}_{u , l} , {ϕ}_{u , l}^{UL} , {ϕ}_{u , l}^{DL} , {θ}_{u , l}^{UL} , and {θ}_{u , l}^{DL}$$

parameters are frequency-independent parameters.

AoAs

$${θ}_{u , l}^{UL}$$

### of UL and AoDs

$${θ}_{u , l}^{DL}$$

of DL are often assumed to be identical due to the inherent symmetry of antenna and path geometry.

$${θ}_{u , l} = {θ}_{u , l}^{UL} = {θ}_{u , l}^{DL}$$

The AoAs may be acquired through a variety of technologies or sensor devices, such as MUSIC and ESPRIT.

Path attenuation parameters,

$${α}_{u , l}^{UL} and {α}_{u , l}^{D L} ,$$

are modeled as follows:

$$- 10 log {α}_{u , l}^{UL} = 20 log ( 4 π {r}_{0} {f}_{k}^{UL} ) + m log ( \frac{{r}_{u , l}}{{r}_{0}} ) + {X}_{u , l}$$

r₀ denotes a reference distance. m denotes a path loss exponent, and X_{u,l} denotes a shadowing parameter.

Among channel attenuation parameters, a path distance r_{u,l} is shared between the UL and DL channels. Since a dominant term

$$m log ( \frac{{r}_{u , l}}{{r}_{0}} )$$

in the formula is the same in both channels, the path attenuation parameters of the UL and DL channels may be considered frequency-dependent terms and may be assumed to be the same.

$${α}_{u , l} = {α}_{u , l}^{UL} = {α}_{u , l}^{D L}$$

A phase change parameter originates from physical phenomena, such as reflection and refraction, so may be assumed to be the same in the UL and DL channels as long as the physical environment of a communication environment does not change.

$${ϕ}_{k , l} = {ϕ}_{k , l}^{UL} = {ϕ}_{k , l}^{D L}$$

Also, the number of channel paths may be considered to be the same in the UL and DL channels, unless the physical environment of the communication environment changes. Therefore, it is assumed that UE locations, AoAs and AoDs, channel attenuation parameters, phase change parameters, and the number of channel paths are all the same in the UL and DL channels of the system considered in the present invention. The UL channel may be easily estimated using existing technologies compared to the DL channel due to the small number of antennas in the UE. Frequency-independent parameters considered in the present invention may be considered as out-of-band information. In the present invention, UL out-of-band information, which may be relatively easily acquired compared to DL, but is also included in the DL channel model as the same value to be capable of estimating the DL channel from the UL parameter, and UL channel information estimated using existing technology are selected as modalities.

A multi-modality selection process using model information according to an example embodiment is described.

If a communication system utilizes model information acquired through the existing technology as training data of deep learning, it is possible to acquire advantages through the guidance of model information rather than relying solely on data, thereby enabling the communication system to achieve better performance. For example, in a channel estimation problem, a DL channel estimated through a least square (LS) channel estimation method or a linear mean squared error (LMMSE) channel estimation method using a DL pilot signal may be utilized as the model information. However, since the accuracy of model information is limited by the performance of existing technologies for estimating the model information, using the model information as training data may limit the performance of DNN training. Also, a method of selecting model information as a modality is suggested in the art. However, since the additional DL training overhead is incurred to acquire model information associated with a DL channel, the present invention does not select model information as a modality.

A training data preprocessing process according to an example embodiment is described.

Each piece of raw data acquired from various modalities has a different data quality. For example, data quality issues include situations in which the mean and variance of raw data may differ, the number of zero values in data may differ, and a data value may be too large or too small to properly reflect the effect of variables or cause gradient vanishing or exploding. Therefore, before utilizing the data for deep learning, a data preprocessing process is required to solve some issues related to the data quality. For example, data scaling, aggregation, normalization, outlier removal, and handling missing data are included in the data preprocessing process.

The present invention may apply the entire data preprocessing process. However, in an example embodiment, a Tanh estimator that has demonstrated the best performance in the results experimentally acquired from the existing deep learning research is considered as the data preprocessing process. The formula for the Tanh estimator preprocessing process is as follows:

$${x}_{norm} = 0.5 [ tanh [ \frac{0.01 ( x - μ )}{δ} ] + 1 ]$$

The Than estimator is sensitive to outliers and converges faster than other normalization technologies, and converts data to a value between −1 and 1 (xₙₒᵣₘ∈└−1,1┘).

Also, missing data is processed as zero based on data having the largest nonzero value in data, such as AoAs or AoDs, which is data of which quantity may vary for each UE among modality data. The present invention consistently adjusts the quality of different modality data through the data preprocessing process, thereby processing the modality data into a form suitable for use in deep learning.

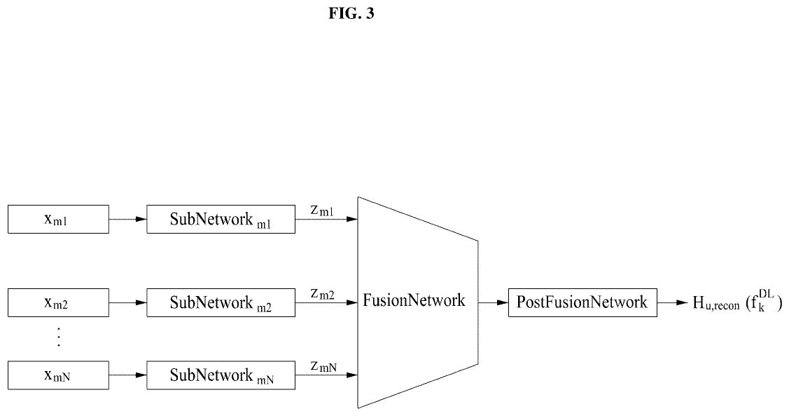

FIG. 3 illustrates the overall structure and a conceptual learning diagram of a DNN utilized in a channel estimation technique according to an example embodiment.

A DNN modeling strategy according to an example embodiment is described.

A channel estimation technique proposed herein learns the relationship between input modalities and a DL channel corresponding to the output in an end-to-end manner. The channel estimation technique proposed herein includes three networks as shown in FIG. 3. In detail, the channel estimation technique includes 1) a subnetwork (SubNetwork) for each modality that compresses input modalities of a DNN to features, 2) a fusion network (FusionNetwork) that fuses the compressed features, and 3) a post-fusion network (PostFusionNetwork) that reconstructs the fused features to the DL channel. Out-of-band information and model information are utilized as input of the DNN. As shown in FIG. 3, the DNN is trained using the preprocessed multi-modal data as the input and using the reconstructed DL channel as the output. The overall input/output relationship of the DNN may be represented as the following formula:

$$\begin{matrix}{z}_{{m}_{1}} = {f}_{{SubNetwork}_{{m}_{1}}} ( {x}_{{m}_{1}} ; {Θ}_{{SubNetwork}_{{m}_{1}}} ) \\ {z}_{{m}_{2}} = {f}_{{SubNetwork}_{{m}_{2}}} ( {x}_{{m}_{2}} ; {Θ}_{{SubNetwork}_{{m}_{2}}} ) \\ ⋮ \\ {z}_{{m}_{N}} = {f}_{{SubNetwork}_{{m}_{N}}} ( {x}_{{m}_{2}} ; {Θ}_{{SubNetwork}_{{m}_{N}}} )\end{matrix}$$

$$\begin{matrix}{z}_{Fusion} = {f}_{FusionNetwork} ( {z}_{{m}_{1}} , {z}_{{m}_{2}} , … , {z}_{{m}_{N}} ; {Θ}_{FusionNetwork} ) \\ {H}_{u , recon} ( {f}_{k}^{DL} ) = {f}_{PostFusionNetwork} ( {z}_{Fusion} ; {Θ}_{PostFusionNetwork} )\end{matrix}$$

Here, m₁, m₂, . . . , m_{N} each denotes multi-modality considered in the present invention.

Also, xₘ_{₁}, xₘ_{₂}, . . . xₘ_{_{N}} each refers to input training data corresponding to the modality.

$${f}_{{SubNetwork}_{{m}_{1}}} , {f}_{{SubNetwork}_{{m}_{2}}} , … , {f}_{{SubNetwork}_{{m}_{N}}}$$

each refers to a SubNetwork that extracts each modality data as each feature, and

$${Θ}_{{SubNetwork}_{{m}_{1}}} , {Θ}_{{SubNetwork}_{{m}_{2}}} , … {Θ}_{{SubNetwork}_{{m}_{N}}}$$

represent parameters of the SubNetwork corresponding to each modality, and zₘ_{₁}, zₘ_{₂}, . . . zₘ_{_{N}} represent features extracted from input training data corresponding to each modality.

f_{FusionNetwork} represents a network that fuses features of modalities extracted from the SubNetwork, Θ_{FusionNetwork} represents parameters of the network, and z_{Fusion} represents the fused feature.

f_{PostFusionNetwork} represents a network that reconstructs the fused feature to a training target,

$${H}_{u , est} ( {f}_{k}^{DL} ) ,$$

Θ_{FusionNetwork} represents parameters of the network, and

$${H}_{u , recon} ( {f}_{k}^{DL} )$$

represents a DL channel matrix that is reconstructed from a feature vector fused from a FusionNetwork in a PostFusionNetwork.

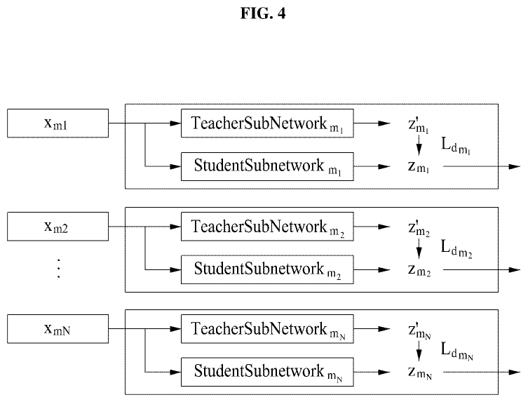

FIG. 4 illustrates a structure and a conceptual learning diagram of a multimodal knowledge distillation-based Teacher-Student SubNetwork that is an example of a SubNetwork utilized in a channel estimation technique according to an example embodiment.

The SubNetwork may be configured with a neural network widely used in deep learning, such as a fully-connected neural network (FNN), a convolutional neural network (CNN), an LSTM, and a GNN. As shown in FIG. 4, the SubNetwork may include, for example, a Teacher-Student SubNetwork based on a multimodal knowledge distillation technique. The proposed Teacher-Student SubNetwork may sufficiently pretrain a TeacherSubNetwork by utilizing the same modality data as a StudentSubNetwork for each modality, and may match features of the trained TeacherSubNetwork and features of the StudentSubNetwork, and accordingly, may prevent the SubNetwork from insufficiently learning any one modality data in joint training and through this, may mitigate the modality laziness problem, thereby maximizing the performance of multimodal deep learning. Features of the proposed Teacher-Student SubNetwork include not only the network output but also intermediate features of the network. The input/output of the proposed multimodal knowledge distillation technique-based Teacher-Student SubNetwork may be represented as the following formula:

$${z}_{{m}_{1}}^{′} = {f}_{{TeacherSubNetwork}_{{m}_{1}}} ( {x}_{{m}_{1}} ; {Θ}_{{TeacherSubNetwork}_{{m}_{1}}} )$$

$${z}_{{m}_{1}} = {f}_{{StudnetSubNetwork}_{{m}_{1}}} ( {x}_{{m}_{1}} ; {Θ}_{{StudnetSubNetwork}_{{m}_{1}}} )$$

$${z}_{{m}_{2}}^{′} = {f}_{{TeacherSubNetwork}_{{m}_{2}}} ( {x}_{{m}_{2}} ; {Θ}_{{TeacherSubNetwork}_{{m}_{2}}} )$$

$${z}_{{m}_{2}} = {f}_{{StudnetSubNetwork}_{{m}_{2}}} ( {x}_{{m}_{2}} ; {Θ}_{{StudnetSubNetwork}_{{m}_{2}}} )$$

$${z}_{{m}_{N}}^{′} = {f}_{{TeacherSubNetwork}_{{m}_{N}}} ( {x}_{{m}_{N}} ; {Θ}_{{TeacherSubNetwork}_{{m}_{N}}} )$$

$${z}_{{m}_{N}} = {f}_{{StudnetSubNetwork}_{{m}_{N}}} ( {x}_{{m}_{N}} ; {Θ}_{{StudnetSubNetwork}_{{m}_{N}}} )$$

$${f}_{{TeacherSubNetwork}_{{m}_{1}}} , {f}_{{TeacherSubNetwork}_{{m}_{2}}} , … , {f}_{{TeacherSubNetwork}_{{m}_{N}}}$$

each represents a TeacherSubNetwork pretrained with training data corresponding to each modality,

$${Θ}_{{TeacherSubNetwork}_{{m}_{1}}} , {Θ}_{{TeacherSubNetwork}_{{m}_{2}}} , {Θ}_{{TeacherSubNetwork}_{{m}_{N}}}$$

represent parameters of the TeacherSubNetwork corresponding to each modality, and

$${z}_{{m}_{1}}^{′} , {z}_{{m}_{2}}^{′} , … , {z}_{{m}_{N}}^{′}$$

represent features extracted from the TeacherSubNetwork corresponding to each modality.

$${f}_{{StudentSubNetwork}_{{m}_{1}}} , {f}_{{StudentSubNetwork}_{{m}_{2}}} , … , {f}_{{StudentSubNetwork}_{{m}_{N}}}$$

each represents the StudentSubNetwork trained with training data corresponding to each modality,

$${Θ}_{{StudnetSubNetwork}_{{m}_{1}}} , {Θ}_{{StudnetSubNetwork}_{{m}_{2}}} , {Θ}_{{StudnetSubNetwork}_{{m}_{N}}}$$

represent parameters of the StudentSubNetwork corresponding to each modality, and zₘ_{₁}, zₘ_{₂}, . . . , zₘ_{_{N}} represent features extracted from each StudentSubNetwork.

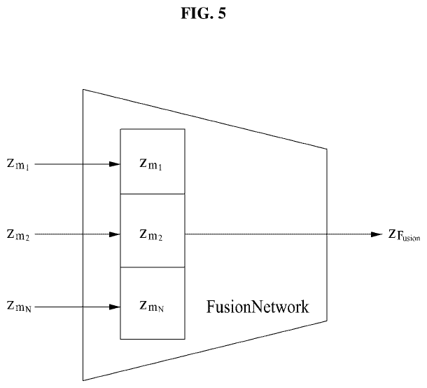

FIG. 5 illustrates a structure and a conceptual learning diagram of a FusionNetwork that is utilized in a channel estimation technique according to an example embodiment.

In an example embodiment, fusion represents a process of generating a single feature by fusing features of modality data extracted from SubNetworks of each modality. The present invention uses features extracted from a StudentSubNetwork as the input of the FusionNetwork. The FusionNetwork may be represented as the following formula:

$${z}_{Fusion} = {f}_{FusionNetwork} ( {z}_{{m}_{1}} , {z}_{{m}_{2}} , … , {z}_{{m}_{N}} ; {Θ}_{FusionNetwork} )$$

f_{FusionNetwork} represents the FusionNetwork that fuses features of each modality data extracted from StudentSubNetworks. z_{Fusion} represents a feature in which features extracted from each StudentSubnetwork are fused into a single feature vector. Θ_{FusionNetwork} represents parameters included in the FusionNetwork.

Feature fusion may be constructed with a DNN. However, according to an example embodiment, the feature fusion may be represented as the following formula in consideration of a concatenation feature fusion method considered in the art:

$${z}_{Fusion} = {f}_{Fusion} ( {z}_{{m}_{1}} , {z}_{{m}_{2}} , … , {z}_{{m}_{N}}$$

f_{Fusion} represents a fusion function that is a function of concatenating features.

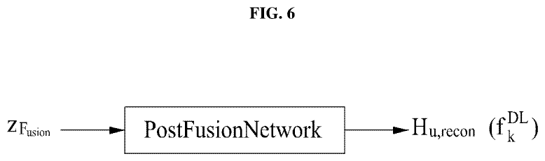

FIG. 6 illustrates a structure and a conceptual learning diagram of a PostFusionNetwork that is utilized in a channel estimation technique according to an example embodiment.

The PostFusionNetwork may be configured with a neural network widely used in deep learning, such as an FNN, a CNN, an LSTM, and a GNN.

Herein, the PostFusionNetwork that uses a feature vector fused in the FusionNetwork as the input and uses an estimated DL channel as output is proposed. The input/output of the proposed PostFusionNetwork may be represented as the following formula:

$${H}_{u , recon} ( {f}_{k}^{DL} ) = {f}_{PostFusionNetwork} ( {z}_{Fusion} ; {Θ}_{PostFusionNetwork} )$$

f_{PostFusionNetwork} denotes the PostFusionNetwork that performs estimation by reconstructing the feature vector fused from the FusionNetwork to the DL channel.

Θ_{PostFusionNetwork} denotes parameters included in the PostFusionNetwork.

The channel estimation technique proposed herein trains the DNN in a supervised learning manner to minimize an error of features extracted from a TeacherSubNetwork and a StudentSubNetwork, and to minimize an error between the DL channel of training data and the DL channel estimated from the DNN. In the present invention, a multimodal loss function for estimation uses the mean squared error (MSE), and the multimodal deep learning technique proposed herein trains the DNN to minimize the MSE that is the error between the DL channel of training data and the DL channel estimated from the DNN by utilizing training data input to the StudentSubNetwork, as shown in the following formula below.

$${ℒ}_{multi} = MSE ( {H}_{u , train} ( {f}_{k}^{DL} ) , {H}_{u , recon} ( {f}_{k}^{DL} ) )$$

In the present invention, the MSE is utilized as a distillation loss function for knowledge distillation, and the proposed multimodal knowledge distillation technique trains the DNN to minimize the MSE that is an error between features extracted from the TeacherSubNetwork and features extracted from the StudentSubNetwork for each modality, as shown in the following formula:

$$\begin{matrix}{ℒ}_{{d}_{{m}_{1}}} = MSE ( {z}_{{m}_{1}} , {z}_{{m}_{1}}^{′} ) \\ {ℒ}_{{d}_{{m}_{2}}} = MSE ( {z}_{{m}_{2}} , {z}_{{m}_{2}}^{′} ) \\ ⋮ \\ {ℒ}_{{d}_{{m}_{N}}} = MSE ( {z}_{{m}_{N}} , {z}_{{m}_{N}}^{′} )\end{matrix}$$

This distillation loss function improves the model performance by allowing the StudentSubNetwork to directly learn the logit of the TeacherSubNetwork.

The distillation loss may be treated as a normalization term of the multimodal loss, such that the proposed multimodal DNN may learn knowledge distilled from the TeacherSubNetwork, while simultaneously learning multimodal information through joint learning. The overall training loss function is designed with a weighted sum to consider both the multimodal loss function and the distillation loss function, and to control the degree to which distillation knowledge is distilled for each modality. For example, when three modalities are considered, the formula may be represented as follows:

$$ℒ = {ℒ}_{multi} + α {ℒ}_{{d}_{{m}_{1}}} + β {ℒ}_{{d}_{{m}_{2}}} + γ {ℒ}_{{d}_{{m}_{3}}}$$

To evaluate the accuracy of the estimated channel, a DL channel of test data is compared with a DL channel estimated using test modality input data to the fully trained DNN using the NMSE, which may be expressed as the following formula:

$$NMSE = E [ \frac{{‖ {H}_{u , test} ( {f}_{k}^{DL} ) - {H}_{u , est} ( {f}_{k}^{DL} ) ‖}_{2}^{2}}{{{H}_{u , test} ( {f}_{k}^{DL} ) ‖}_{2}^{2}} ]$$

$${H}_{u , test} ( {f}_{k}^{DL} )$$

denotes a test DL channel matrix.

$${H}_{u , est} ( {f}_{k}^{DL} )$$

denotes a DL channel matrix estimated using multimodal test data for the trained DNN.

FIG. 7 is a flowchart illustrating a multimodal learning-based FDD mMIMO downlink channel estimation method according to an example embodiment.

The multimodal learning-based FDD mMIMO downlink channel estimation method according to an example embodiment includes selecting, through a multi-modality selector, multi-modal data for deep learning based on partial channel reciprocity to estimate a channel of an FDD mMIMO system (710), preprocessing, through a preprocessing unit, the selected multi-modality to training data for channel estimation (720), performing, through a multimodal DNN modeling unit, multimodal DNN modeling based on a multimodal knowledge distillation technique for solving a modality laziness problem using the preprocessed multi-modal data (730), and estimating, through a multimodal DNN training unit, a downlink channel of the FDD mMIMO system by training a multimodal DNN model (740).

In operation 710, through the multi-modality selector, multi-modal data for deep learning is selected based on the partial channel reciprocity to estimate the channel of the FDD mMIMO system.

According to an example embodiment, to estimate the downlink channel of the FDD mMIMO system, out-of-band information based on model information of the system and geometric channel reciprocity is selected as training modality data for multimodal deep learning.

According to an example embodiment, uplink out-of-band information and uplink channel information for estimating the downlink channel is selected from among uplink-related parameters as training modality data for multimodal deep learning, and the out-of-band information is a frequency-independent parameter.

In operation 720, through the preprocessing unit, the selected multi-modality is preprocessed to training data for channel estimation.

According to an example embodiment, data preprocessing including data scaling, aggregation, normalization, outlier removal, and handling missing data is performed to consistently match the quality of different modality data for the selected multi-modality for multimodal deep learning.

In operation 730, through the multimodal DNN modeling unit, multimodal DNN modeling is performed based on the multimodal knowledge distillation technique for solving the modality laziness problem using the preprocessed multi-modal data.

In operation 740, through the multimodal DNN training unit, the downlink channel of the FDD mMIMO system is estimated by training the multimodal DNN model.

According to an example embodiment, the multi-modal data is compressed to features through a subnetwork (SubNetwork) for each of the multi-modal data using the preprocessed multi-modal data as input, the compressed features are fused through a fusion network (FusionNetwork), and the fused features are reconstructed to the downlink channel through a post-fusion network (PostFusionNetwork).

According to an example embodiment, a distillation loss function is selected as the MSE, such that the subnetwork performs deep learning using information of a teacher network distilled using the multimodal knowledge distillation technique.

According to an example embodiment, a multimodal loss function is computed, such that the subnetwork performs deep learning on information of all modalities, and a final loss function is computed in such a manner that a student network of the subnetwork learns information of all modalities and information distilled from a teacher network.

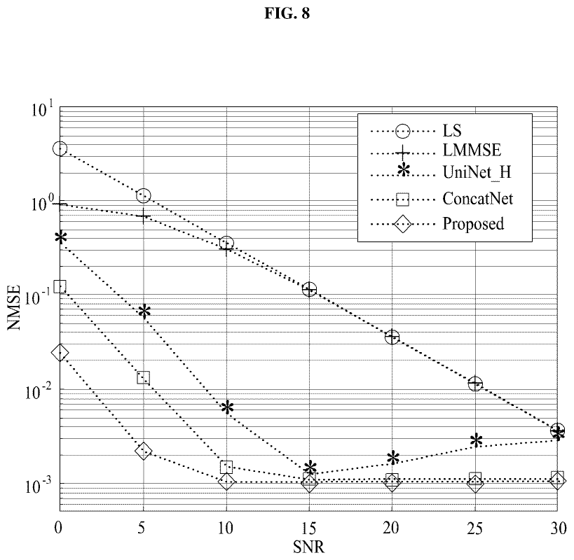

FIG. 8 is a graph comparing the NMSE performance between a channel estimation technique according to an example embodiment and the existing channel estimation technique.

According to an example embodiment, as shown in FIG. 8, by utilizing various modality data capable of improving the performance of the system, such as out-of-band information or model information, complementary information, which may be present in different modalities, may be used to train a DNN. By mitigating the modality laziness problem that is one of problems of existing multimodal deep learning, more accurate channel estimation may be performed than the existing channel estimation technique. Also, the proposed technique may effectively reduce the overhead since a large number of pilot signals and feedback loops required in the existing FDD mMIMO system are not required.

The proposed technique may reduce the overhead required in the DL channel estimation technology of the existing FDD mMIMO system by utilizing, as modality data, frequency-independent parameters that are model information of the UL channel, which is relatively easy to acquire compared to DL, and out-of-band information. Also, by reflecting complementary information of frequency-independent various modality data of a channel in a DNN training process, channel estimation may be improved compared to the existing channel estimation technology. A channel estimation method proposed herein is data-driven, so may be applied to ultra-high frequency communication, such as terahertz and millimeter waves. The proposed channel estimation method may solve the difficulty in DL channel estimation due to the insufficient reciprocity between UL and DL of FDD, and may improve the performance of the existing communication technology based on channel estimation using the channel estimated with high accuracy. Also, the proposed technique relates to a technology for an FDD mode that is an infrastructure of the existing cellular network, and thus may be immediately applied without significantly changing the existing infrastructure. Therefore, the proposed invention may contribute to the realization of an ultra-precision and ultra-high-performance large-scale communication network.

The apparatuses described herein may be implemented using hardware components, software components, and/or combination of the hardware components and the software components. For example, the apparatuses and the components described herein may be implemented using one or more general-purpose or special purpose computers, such as, for example, a processor, a controller, an arithmetic logic unit (ALU), a digital signal processor, a microcomputer, a field programmable gate array (FPGA), a programmable logic unit (PLU), a microprocessor, or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will be appreciated that the processing device may include multiple processing elements and/or multiple types of processing elements. For example, the processing device may include multiple processors or a processor and a controller. In addition, different processing configurations are possible, such as parallel processors.

The software may include a computer program, a piece of code, an instruction, or at least one combination thereof, for independently or collectively instructing or configuring the processing device to operate as desired. Software and/or data may be embodied in any type of machine, component, physical equipment, virtual equipment, a computer storage medium or device, to be interpreted by the processing device or to provide an instruction or data to the processing device. The software also may be distributed over network coupled computer systems so that the software is stored and executed in a distributed fashion. The software and data may be stored by one or more computer readable storage media.

The methods according to the example embodiments may be configured in a form of program instructions performed through various computer methods and recorded in computer-readable media. The media may also include, alone or in combination with the program instructions, data files, data structures, and the like. The program instructions recorded on the media may be those specially designed and constructed for the purposes of the example embodiments, or they may be of the well-known kind and available to those having skill in the computer software arts. Examples of the media include magnetic media such as hard disks, floppy disks, and magnetic tapes; optical media such as CD-ROM and DVDs; magneto-optical media such as floptical disks; and hardware devices that are configured to store program instructions, such as read-only memory (ROM), random access memory (RAM), flash memory, and the like. Examples of program instructions include both machine code, such as code produced by a compiler, and files containing higher level code that may be executed by the computer using an interpreter.

Although the example embodiments are described with reference to some specific example embodiments and accompanying drawings, it will be apparent to one of ordinary skill in the art that various alterations and modifications in form and details may be made in these example embodiments without departing from the spirit and scope of the claims and their equivalents. For example, suitable results may be achieved if the described techniques are performed in different order, and/or if components in a described system, architecture, device, or circuit are combined in a different manner, and/or replaced or supplemented by other components or their equivalents.

Therefore, other implementations, other example embodiments, and equivalents of the claims are to be construed as being included in the claims.

What is claimed is:

1. A multiple-input multiple-output (MIMO) downlink channel estimation system comprising:
a multi-modality selector configured to select multi-modal data for deep learning based on a partial channel reciprocity to estimate a channel of a frequency division duplexing (FDD) massive MIMO (mMIMO) system;
a preprocessing unit configured to preprocess the selected multi-modal data to training data for channel estimation;
a multimodal deep neural network (DNN) modeling unit configured to perform multimodal DNN modeling based on a multimodal knowledge distillation technique for solving a modality laziness problem using the preprocessed multi-modal data; and
a multimodal DNN training unit configured to estimate a downlink channel of the FDD mMIMO system by training a multimodal DNN model.

2. The MIMO downlink channel estimation system of claim 1, wherein the multi-modality selector is configured to select out-of-band information based on model information of the system and a geometric channel reciprocity as training modality data for multimodal deep learning, to estimate the downlink channel of the FDD mMIMO system.

3. The MIMO downlink channel estimation system of claim 2, wherein the multi-modality selector is configured to select uplink out-of-band information and uplink channel information for estimating the downlink channel from among uplink-related parameters as the training modality data for multimodal deep learning, and
the out-of-band information is a frequency-independent parameter.

4. The MIMO downlink channel estimation system of claim 1, wherein the preprocessing unit is configured to perform data preprocessing including data scaling, aggregation, normalization, outlier removal, and handling missing data to consistently match the quality of different modality data for the selected multi-modality for multimodal deep learning.

5. The MIMO downlink channel estimation system of claim 1, wherein the multimodal DNN training unit is configured to,
compress the multi-modal data to features through a subnetwork (SubNetwork) for each of the multi-modal data using the preprocessed multi-modal data as input,
fuse the compressed features through a fusion network (FusionNetwork), and
reconstruct the fused features to the downlink channel through a post-fusion network (PostFusionNetwork).

6. The MIMO downlink channel estimation system of claim 5, wherein the multimodal DNN training unit is configured to select a distillation loss function as the mean squared error (MSE), such that the subnetwork performs deep learning using information of a teacher network distilled with the multimodal knowledge distillation technique.

7. The MIMO downlink channel estimation system of claim 5, wherein the multimodal DNN training unit is configured to,
compute a multimodal loss function, such that the subnetwork performs deep learning on information of all modalities, and
compute a final loss function in such a manner that a student network of the subnetwork learns information of all modalities and information distilled from a teacher network.

8. A multiple-input multiple-output (MIMO) downlink channel estimation method comprising:
selecting, through a multi-modality selector, multi-modal data for deep learning based on a partial channel reciprocity to estimate a channel of a frequency division duplexing (FDD) massive MIMO (mMIMO) system;
preprocessing, through a preprocessing unit, the selected multi-modal data to training data for channel estimation;
performing, through a multimodal deep neural network (DNN) modeling unit, multimodal DNN modeling based on a multimodal knowledge distillation technique for solving a modality laziness problem using the preprocessed multi-modal data; and
estimating, through a multimodal DNN training unit, a downlink channel of the FDD mMIMO system by training a multimodal DNN model.

9. The MIMO downlink channel estimation method of claim 8, wherein the selecting, through the multi-modality selector, multi-modal data for deep learning based on partial channel reciprocity to estimate the channel of the FDD mMIMO system comprises selecting out-of-band information based on model information of the system and a geometric channel reciprocity as training modality data for multimodal deep learning, to estimate the downlink channel of the FDD mMIMO system.

10. The MIMO downlink channel estimation method of claim 9, wherein the selecting, through the multi-modality selector, multi-modal data for deep learning based on partial channel reciprocity to estimate the channel of the FDD mMIMO system comprises selecting uplink out-of-band information and uplink channel information for estimating the downlink channel from among uplink-related parameters as the training modality data for multimodal deep learning, and
the out-of-band information is a frequency-independent parameter.

11. The MIMO downlink channel estimation method of claim 8, wherein the preprocessing, through the preprocessing unit, the selected multi-modality to training data for channel estimation comprises performing data preprocessing including data scaling, aggregation, normalization, outlier removal, and handling missing data to consistently match the quality of different modality data for the selected multi-modality for multimodal deep learning.

12. The MIMO downlink channel estimation method of claim 8, wherein the estimating, through the multimodal DNN training unit, the downlink channel of the FDD mMIMO system by training the multimodal DNN model comprises:
compressing the multi-modal data to features through a subnetwork (SubNetwork) for each of the multi-modal data using the preprocessed multi-modal data as input;
fusing the compressed features through a fusion network (FusionNetwork); and
reconstructing the fused features to the downlink channel through a post-fusion network (PostFusionNetwork).

13. The MIMO downlink channel estimation method of claim 12, wherein the estimating, through the multimodal DNN training unit, the downlink channel of the FDD mMIMO system by training the multimodal DNN model comprises selecting a distillation loss function as the mean squared error (MSE), such that the subnetwork performs deep learning using information of a teacher network distilled with the multimodal knowledge distillation technique.

14. The MIMO downlink channel estimation method of claim 12, wherein the estimating, through the multimodal DNN training unit, the downlink channel of the FDD mMIMO system by training the multimodal DNN model comprises:
computing a multimodal loss function, such that the subnetwork performs deep learning on information of all modalities; and
computing a final loss function in such a manner that a student network of the subnetwork learns information of all modalities and information distilled from a teacher network.

15. A non-transitory computer-readable recording medium storing instructions to execute a multiple-input multiple-output (MIMO) downlink channel estimation method through a multimodal learning-based frequency division duplexing (FDD) massive MIMO (mMIMO) downlink channel estimation system, wherein the MIMO downlink channel estimation method comprises:
selecting, through a multi-modality selector, multi-modal data for deep learning based on a partial channel reciprocity to estimate a channel of a frequency division duplexing (FDD) mMIMO system;
preprocessing, through a preprocessing unit, the selected multi-modal data to training data for channel estimation;
performing, through a multimodal deep neural network (DNN) modeling unit, multimodal DNN modeling based on a multimodal knowledge distillation technique for solving a modality laziness problem using the preprocessed multi-modal data; and
estimating, through a multimodal DNN training unit, a downlink channel of the FDD mMIMO system by training the multimodal DNN model.
